(19) United States
(12) Patent Application Publication
(10) Pub. No.: US 2006/0041606 A1
(43) Pub. Date: Feb. 23, 2006

(54) Indexing system for a computer file store

(75) Inventor: Edwin Thomas Sawdon, Stoke-on-Trent (GB)

Correspondence Address: BARNES & THORNBURG, LLP, P.O. BOX 2786, CHICAGO, IL, 60690-2786, US

(73) Assignee: Fujitsu Services Limited

(21) Appl. No.: 11/178,694

(22) Filed: Jul. 11, 2005

(30) Foreign Application Priority Data
Aug. 19, 2004 (GB) GB 04 18514.6

(51) Int. Cl. G06F 17/30

(52) U.S. Cl. 707/205

(57) ABSTRACT

A computerized document retrieval system has a file store holding a collection of documents, and indexer for constructing and updating at least one index from the contents of the documents, and a search engine for searching the index to retrieve documents from the file store. The indexer comprises three asynchronously executable processes: (a) a crawl process, which scans the file store to find documents requiring to be indexed, (b) an extract process, which accesses the documents requiring to be indexed and extracts indexing data from them, and (c) a build process, which uses the indexing data to construct or update the index.

### BACKGROUND TO THE INVENTION

This invention relates to a method and apparatus for indexing documents in a computer file store.

It is well known to index such a collection of documents, to allow rapid searching. For example, the documents may be indexed by building one or more inverted indexes, containing a number of indexing terms (e.g. words) as keys.

As documents are modified, added to or deleted from the collection, it is clearly necessary to update the index. This may be done either in an incremental manner, i.e. making only those changes necessary to reflect the updates to the documents, or by completely rebuilding the index. However, if the number of updates is very large, updating the index can take a very long time. Thus, any updates to the document collection will not be visible to a search until some time after they have been made, which is clearly undesirable.

The object of the present invention is to provide a novel system for updating an index, which has the potential for improving the time needed to perform updates.

### SUMMARY OF THE INVENTION

According to one aspect of the invention, a computer system comprises a file store for holding a collection of documents, indexing means for constructing and updating at least one index from the contents of the documents, and search means for searching the index to retrieve documents from the file store, wherein the indexing means comprises the following asynchronously executable processes: (a) a crawl process, for scanning the file store to find documents requiring to be indexed; (b) an extract process, for accessing the documents requiring to be indexed and extracts indexing data from them; and (c) a build process, for using the indexing data to construct or update the index.

It will be shown that the use of separate, asynchronously executable crawl, extract and build processes in this way provides a number of advantages. In particular, it enables a number of instances of the extract process to be run in parallel, thereby alleviating a potential bottleneck in the index updating.

### BRIEF DESCRIPTION OF THE DRAWINGS

FIG. 1 is an overall view of a computerized document retrieval system including an indexing system in accordance with the invention.

FIG. 2 shows the indexing system in more detail.

FIG. 3 is a flowchart of a crawl process.

FIG. 4 is a flowchart of an extract process.

FIG. 5 is a flowchart of a build process.

### DESCRIPTION OF AN EMBODIMENT OF THE INVENTION

A computerized document retrieval system including an indexing system in accordance with the invention will now be described by way of example with reference to the accompanying drawings.

System Overview

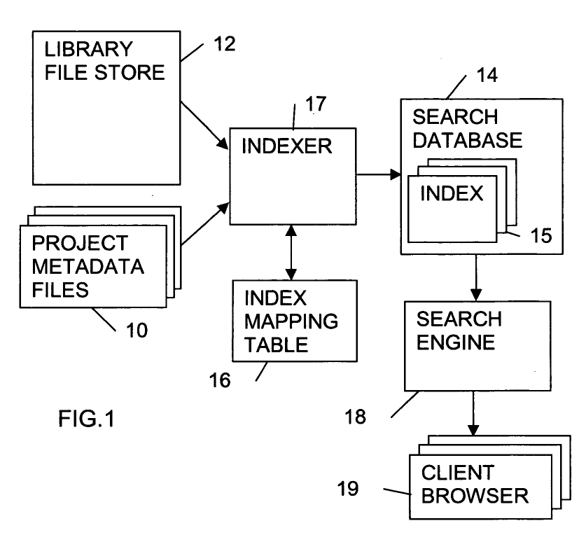

FIG. 1 shows an overall view of the document retrieval system. A set of project metadata files 10 define a number of projects within the system. The project metadata includes, for example, such things as project ID, and project user groups (the users who are allowed to access and update the project's documents). The project metadata also defines a hierarchy of project categories, and specifies the directories in which the project's document files are stored.

A library file store 12 holds a large number of document files. Each document belongs to a particular project, and is stored in one of the project's directories. The documents may be of many different types, including for example .zip files, .gif files, .pdf files and .htm files.

The file store 12 also holds document metadata files, specifying metadata for individual documents. Each document metadata file is stored in the library file store in the same directory as the document to which it relates, and has a name that is derived from the name of the document by adding special prefix to the document name. The document metadata includes, for example, such things as document identity, document title, author, and time stamp (indicating the last modification date and time).

A search database 14 holds a set of indexes 15 for use in searching the file store. In the present example, there are sixteen indexes. Each project is mapped on to a particular one of the indexes, so as to load-share the projects between the indexes. As a result, when a project is updated, it is necessary to update only one relatively small index, rather than one large one. The mapping of the projects to indexes is specified by an index mapping table 16. This table contains an entry for each project. Each entry contains the following attributes: the project ID, the name/ID of the index to which this project has been allocated, and a count value. The count value is initially set equal to the number of documents in the project, and is incremented each time a document is modified or added. The mapping of projects to indexes does not change, except in the case where a full index rebuild is performed. The indexes are built and maintained by an indexer 17.

The indexes are used by a search engine 18 (in the present embodiment, the Fujitsu iTracer search engine) to search for documents in the library file store. The search engine interfaces with users through a number of client browsers 19, which may be conventional web browser programs.

The document retrieval system shown in FIG. 1 may be implemented on a single computer, but preferably it is distributed across a number of separate computers, interconnected by a network such as the Internet or a local area network. For example, the library file store, the search database, the search engine and the indexer may be distributed across a number of server computers, while the client browsers may be located on individual users' personal computers.

Indexer Overview

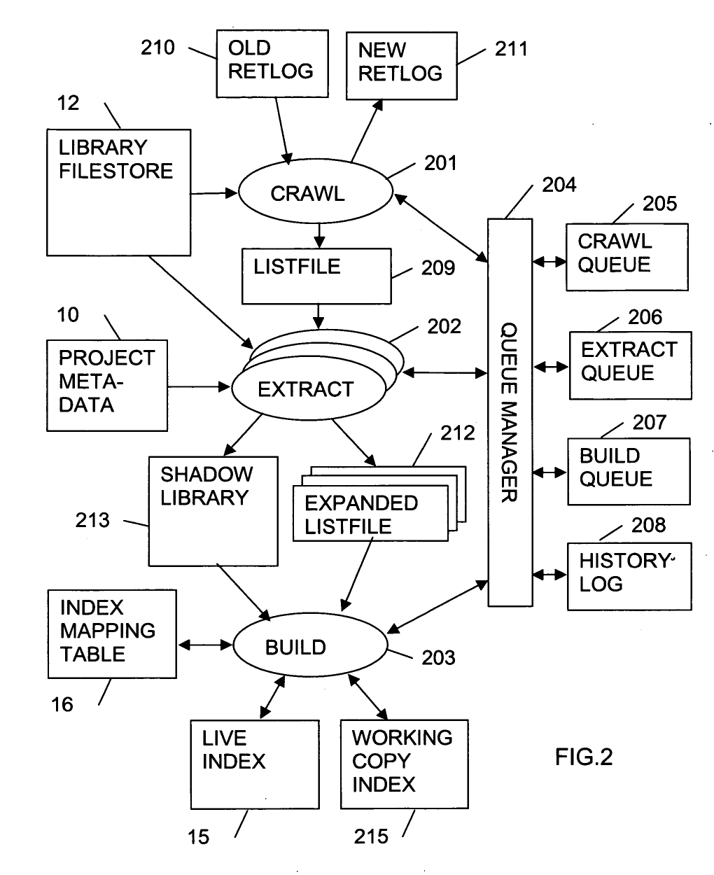

FIG. 2 shows the indexer 17 in more detail.

The indexer includes a crawl process 201, an extract process 202, and a build process 203. The three processes 201-203 run independently and asynchronously. These processes are daemon style processes which run continuously, doing incremental updates to the indexes.

A queue manager 204 maintains a crawl queue 205, an extract queue 206, and a build queue 207, which hold queues of projects waiting to be processed by the crawl, extract and build processes. The queue manager also maintains a history log 208.

The crawl process 201 gets a project from the crawl queue, and scans (“crawls”) the library file store to find files belonging to the project that have been modified, created or deleted since the last crawl. The crawl process creates a listfile 209 for the project, containing an entry for each such file. When it has finished processing a project, the crawl process moves the project to the extract queue. The crawl process uses a pair of retrieval log files, referred to as the old retlog 210 and the new retlog 211. The old retlog contains file names and time stamps of the files that have been retrieved in the last crawl; the new retlog contains file names and time stamps of the files that have been retrieved in the current crawl.

The extract process 202 gets a project from the extract queue. It then processes the project's listfile 209, by extracting indexing data from the project documents. The indexing data is added to the project's listfile, along with other custom data, to produce an expanded listfile 212. When it has finished processing a project, the extract process moves the project to the build queue.

The build process 203 retrieves projects from the build queue, and identifies the index associated with the first project, using the index mapping table. The build process then updates that index with changes from all queued projects associated with that index. When the index is updated with changes from a project, the build process moves that project to the history log 208.

The indexer also maintains a cache store, referred to as the shadow library 213, which holds a copy of the extracted indexing data and custom data for each document. This is organised in a hierarchical tree structure similar to that of the library file store, so that the cached data for a document can be accessed given the library address and path of the document. The shadow library is updated by the extract process whenever a document is updated or its metadata changes. As will be shown, the shadow library can be used instead of the library file store for purposes such as index rebuilding, avoiding the need to extract the indexing data from the documents.

The extract process 202 is likely to be the main bottleneck of the indexing system, because extracting indexing information from documents is very expensive in terms of resources. For this reason, a number of instances of the extract process can be run in parallel on parallel servers.

The various components of the indexer will now be described in more detail.

The Queue Manager

The queue manager 204 is implemented as an API module. Each of the indexing processes (crawl, extract and build) can call the API in order to manage work flow through the system. Each queue is a directory and project entries within a queue are simple state files.

The input to the crawl queue 205 is managed by finding all projects that are eligible for crawling and determining which is the most eligible. More specifically, when the crawl process requests a project, the queue manager performs the following steps in an atomic operation:
Retrieves a working-set list of currently active projects.
Adds to this list any projects for which the project metadata has changed.
Removes from the list those projects which are currently in the extract or build queues.
Determines the most eligible project to crawl as the one which is least recently processed i.e. the oldest project record in the history log (taking into account that absence from the log means that the project is even older and more worthy of crawling).
The most eligible project is placed in the crawl queue and given to the crawl process.

It can be seen that only active projects are selected as candidates for crawling and hence for indexing. This helps to reduce the workload of the indexer, and to speed up incremental index updates.

While the crawl is in progress, the project remains in the crawl queue; there will only ever be one project in the crawl queue, it is the active project. On successful completion, the project is moved to the extract queue. If the crawl fails or no document changes are detected, the project is moved directly to the history log; it is still eligible for crawling, but at this point it will be the least eligible.

The extract queue 206 is a first-in-first-out (FIFO) list: projects are added to in the extract queue after being crawled, and they are removed in the same order.

The extract queue can be used in a multi-processing environment, so as to allow it to be accessed by multiple extract processes (one on each available server). The queue manager uses non-mandatory file locking on project state files to ensure that a project is extracted by a single dedicated extract process.

In order to prevent overloading of the extract stage, the queue manager stops giving new projects to the crawl process whenever the number of projects in the extract queue is greater than a predetermined threshold value. In other words, the queue manager throttles the crawl process in accordance with the size of the extract queue. The threshold value is configurable, and will typically be equal to twice the number of servers running the extract process. Throttling ensures that the time lag between the start of crawling and the completion of extraction does not become excessive.

The build queue 207 is also a FIFO. When the build process is ready to accept projects to build, it requests all projects in the queue. The queue manager then returns a list of all the projects currently in the build queue, in FIFO order. However, as will be described, although the build process receives projects from the build queue in FIFO order, it does not process them in that order. Instead, the build process selects the first project in the build queue for processing, and then all other projects that use the same index. This ensures that processing of projects that use the same index are grouped together, which optimizes the index updates.

Processed projects are moved from the build queue to the history log 208.

Crawl Process

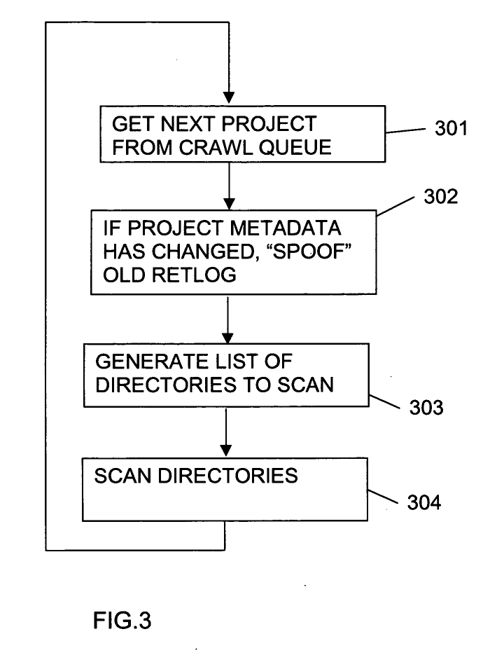

The crawl process 201 is shown in FIG. 3.

(Step 301) The crawl process runs in a continuous loop requesting projects from the crawl queue.

(Step 302) When it receives a project from the crawl queue, the crawl process accesses the project metadata and checks whether the project metadata has been changed since the last crawl.

If so, the old retlog 210 is “spoofed” by decrementing each file's timestamp by two hours. This is done to make it appear that all of the project's files have been updated, so as to force a complete re-indexing of the project. This is necessary because the change in project metadata may change every document's indexing data (e.g. project name), and so it is necessary to re-index them all, even if their body text has not changed.

(Step 303) The crawl process uses the project metadata to generate a list of the directories that are to be scanned, i.e. all the category directories that contain the project files.

(Step 304) The crawl process then calls the iTracer isulistfile utility to scan these directories (and any sub-directories) so as to find all the files belonging to the project. By comparing the results of this scan with the contents of the old retlog, isulistfile identifies which of these files have been modified, added or deleted since the last crawl, and appends an entry for each such file to the project's listfile 209. If the old retlog does not exist, isulistfile adds all of the project's files to the listfile 209.

It should be noted that the isulistfile utility will detect both document files and document metadata files that have been modified, added or deleted.

The listfile 209 is standard iTracer listfile. It is a text file containing XML tags identifying entries for new, modified or deleted files and identifying basic details of the files including file path, file size, date last modified (format YYYYMMDD), and file type.

For example, the following listfile contains an entry indicating that a document index. htm has been modified:

<document-list>

```
<replace>
  <LOCATION>/Proj/PW0001/s01/c01/index.html</LOCATION>
  <PATH>/proj1/htdocs/GSN0002/pjwebroot/lib/PW0001/s01/c
01/PW_Library_structurev1.doc</PATH>
  <TYPE>doc</TYPE>
  <DATE>20010703</DATE>
  <SIZE>28160</SIZE>
</replace>
...
```

</document-list>

It can be seen that, if project metadata has been changed and the retlog has been “spoofed”, isulistfile will add all of the project's files to the listfile for re-indexing, because it will appear that all those files have been modified since the last crawl. In particular, if the project metadata has been changed so as to delete a particular category in the project, all the files in that category will be listed as “delete” items.

The file name and time stamp of each of the files identified in the current crawl is added to the new retlog file 211. The next time the project is crawled, this file becomes the old retlog 210.

Extract Process

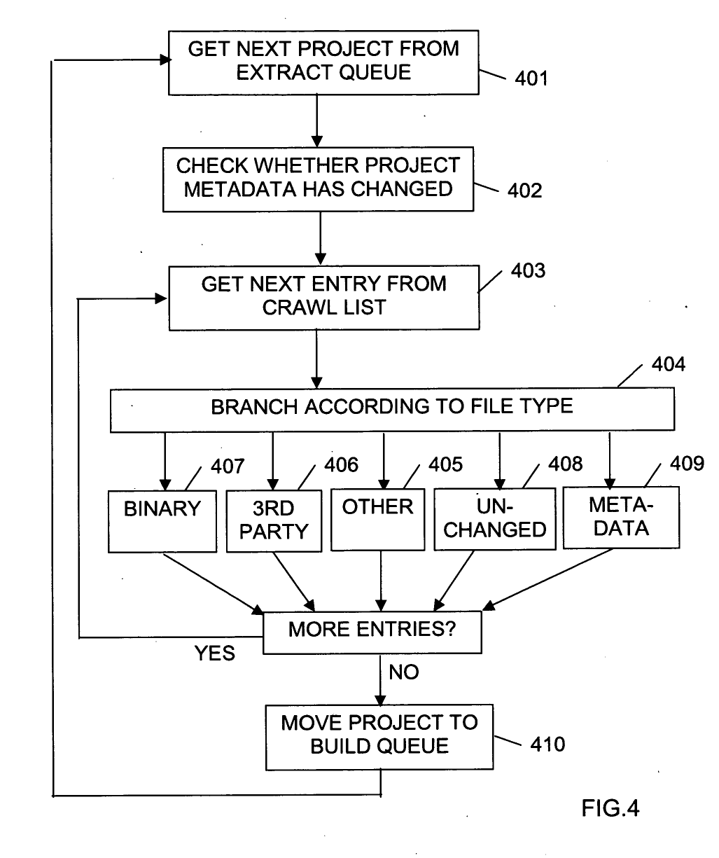

The extract process is shown in FIG. 4.

(Step 401) The extract process runs in a continuous loop, requesting projects from the extract queue. A number of extract processes may run in parallel, one on each of a number of parallel servers. Each extract process is allowed to extract only one project at a time, and a project will be extracted by a single extract process only.

(Step 402) The extract process first checks whether the project metadata has changed.

(Step 403) The extract process then accesses each entry in the project's listfile 209. Each of these entries relates to a particular file within the project.

(Step 404) If it was detected in step 402 that the project metadata has not changed, the file is classified as one of the following types:
Binary (e.g. .zip, .gif files)
3rd party (e.g. .pdf files)
Other (other types of document file, e.g. .htm files)

(Step 405) Files of type “other” are processed by calling the iTracer isufilter utility. This accesses the file, and extracts (filters) any body content (i.e. text) from it, ignoring any embedded images, formatting information etc. The extracted body text is added to the listfile entry, encapsulated in XML <body> . . . </body> tags.

The extract process also reads custom data from the library file system, the document metadata, and the project metadata, and adds this custom data to the listfile entry, encapsulated in appropriate XML tags. The custom data may include for example the document ID, the logical path and filename, document title, last modification date/time, project ID, library path, project name, document project key, project user groups, and document metadata.

The extracted body text and added custom data constitute the indexing data, which will be used by the build process 203 to update the relevant index 15.

The listfile entry, enhanced with this indexing data, is written to the expanded listfile 212, and also to the shadow library 213.

(Step 406) Files of type “3rd party” are processed by calling an appropriate 3 rd party filter. This extracts the body text from the document, performing any necessary format conversions, and adds the extracted body text to the entry. As before, the entry is embellished with custom data, and written to the expanded listfile 212 and to the shadow library 213.

(Step 407) In the case of files of type “binary”, no body text is filtered from the file: binary files will be indexed without body extracts, and so cannot be found by a search on body text. As before, the entry is embellished with custom data, and written to the expanded listfile 212 and to the shadow library 213. If it is found at step 402 that the project metadata has changed, then all of the project's files will be in the listfile 209 (as a result of“spoofing” the old retlog file as described above). This is desirable since it enables re-indexing of all the project's documents in order to cater for possible changes in every document's data (e.g. project name). However it is probable that most or all of the documents have not been modified and so do not require any body content extraction (an expensive operation). To avoid unnecessary document extraction, in this case step 404 is modified to introduce another classification, “unchanged”. Unchanged files are detected by comparing the time stamp in the file's shadow library entry with the time stamp for the file in the retlog file produced by the crawl process. It should be noted that step 404 tests for unchanged files only if the project metadata has changed.

(Step 408) “Unchanged” files are processed by reading the document's body text (if any) from the shadow library 213, and adding it to the listfile entry. This is much less expensive than extracting the body text from the document itself. The listfile entry is embellished with the customised data as described above and then written to the expanded listfile 212 and to the shadow library 213.

Another special case for classification at step 404 is in the case of changed instance metadata. In this case, the target document has not changed, but its instance metadata has. Thus, the document has to be re-indexed, but it is not necessary to extract the document body content. From the perspective of the crawl process (and isulistfile) the updated instance metadata file is simply an updated file and so an entry will have been created for it in the listfile 209. From the perspective of the extract process, it can be recognised as an instance metadata file by the format of its name, i.e. by its special prefix.

(Step 409) “Changed instance metadata” files are processed as follows. The extract process first reconstructs the name of the target document (i.e. the document to which the metadata file relates) from the name of the metadata file, by removing the special prefix. It then creates an entry in the listfile 212 for the target document (not the metadata file). This entry is then processed in the same manner as for the “unchanged” case described above: body text (if any) is added from the document's entry in the shadow library, the entry is embellished with custom data (including the updated metadata), and the entry is written to the expanded listfile 212 and to the shadow library 213.

(step 410) When all the entries in the listfile 209 have been processed, the project is moved to the build queue.

Build Process

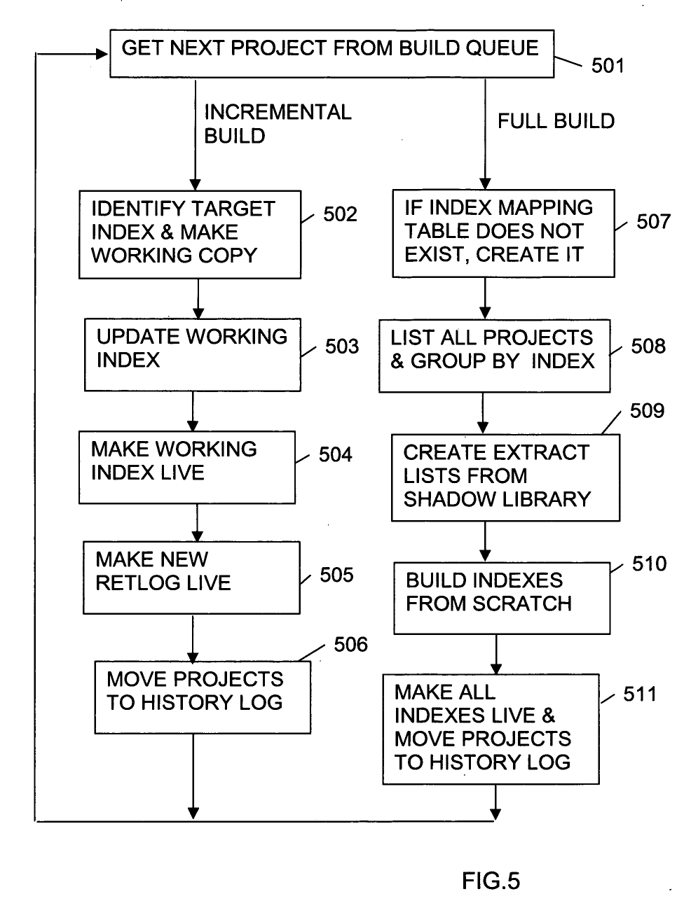

The build process is shown in FIG. 5.

(Step 501) The build process runs in a continuous loop requesting lists of projects from the build queue.

In response to a request from the build process, the queue manager will normally return the whole build queue in FIFO order, and the build process will then perform an incremental index build. However, if a full index build has been requested by the user, the queue manager will instead return a “do full build” signal, forcing the build process to completely rebuild the indexes.

For incremental builds, the build process is as follows.

(Step 502) The build process identifies the index for the first project in the build queue, using the index mapping table 16. This is referred to as the target index. The build process then makes a working copy of the target index.

In the case of a new project, an index is allocated by selecting the index with the lowest document count (found by simple processing of the index mapping table entries). The a new entry is added to the index mapping table 16, including the new project ID, the index ID, and the new project's document count.

A special case is where the index mapping table 16 does not exist. In this case, incremental builds cannot be processed since the build process cannot find which index to update. In this case therefore, all incremental builds are moved to the history log without updating the index. When build receives a full index build request (see below) it will create a new index mapping table and optimally balanced index mapping, as described below.

(Step 503) The build process also identifies any other projects in the build queue that map on to the target index. For each project that maps on to the target index, the build process accesses the expanded listfile 212 for the project and uses the indexing data in this listfile to update the working copy index (using the iTracer isuindex tool).

(Step 504) When all the projects that map on to the target index have been processed, the build process makes the updated working copy index live (i.e. replaces the existing target index with the working copy). It also updates (increments) each project's document count in the index lookup table with the number of documents in this project update.

(Step 505) The build process then makes the project's new retlog file live (i.e. replaces the old retlog with the new retlog). This new retlog is in step with the index that has just been put live, and so subsequent crawls will find files with content newer than contained in the index.

(Step 506) Finally, the build process moves the updated projects to the history log.

In the case of a full index build, the build process performs the following steps.
(Step 507) If an index mapping table 16 does not exist, the build process creates one as follows.

First, the build process counts the number of documents in each project. It does this by tree-walking the project categories in the shadow library according to the project metadata. A performance shortcut can be made if the project has a retlog (which will contain an inventory of the project's library): in this case, the number of lines in the retlog gives the number of documents in the project's library. The projects are sorted in descending size order, those projects with most documents first, those with fewest last.

An empty index mapping table is then created. The first (largest) project is allocated to index 1. A project entry, containing the project ID, the index ID (=1), and the project's document count, is written to the empty index mapping table. Each subsequent project is taken in turn and allocated the index with the least number of documents in it, and again a project entry is created and added to the index mapping table. The process of sorting projects by size and allocating the biggest first leads to optimal balancing of projects to indexes.

(Step 508) The build process then makes a full list of projects (from the project metadata), and groups these projects according to which index they belong to.

(Step 509) For each index, the process creates listfiles 212 for all projects associated with this index. The listfiles 212 are created by tree-walking the shadow library 213 (according to the project metadata category data) and concatenating shadow file entries. It should be noted that because the shadow library contains body content that has already been extracted from the documents, this is much quicker than would be the case if the body content had to be extracted from the documents.

(Step 510) When all listfiles 212 have been created for an index, the build process builds the index from scratch.

(Step 511) When all indexes have been created, they are all put live one after another in quick succession. Under normal circumstances all indexes will be published over the course of a couple of minutes, but there will be no interruption to the search service, and any period of inconsistency is minimised. As each index is put live, the associated projects are moved to the history log.

Initiating a Full Index Build

Full building of the search indexes is required from time to time to keep the search performance optimal: an index that is continually incrementally updated will eventually suffer from fragmentation and degradation of performance. Typically, such a full index build would be performed at off-peak times, for example on a Sunday, when the system usage is low. Full index building may also be required to re-optimise the index mapping table. This can be done by deleting the index lookup configuration file and scheduling a full index build. Note that this administrative procedure will lead to search inconsistencies over the minutes between the first index being published and the final index being published.

A command line utility is provided to allow a system administrator to schedule a full index build. A full index build will rebuild all search indexes from scratch from the shadow library; no crawling or extracting is required to do the full build (providing the library has been completely crawled and extracted at some time prior to the full build).

When the command line utility is used to schedule a full build, it puts the queue manager into a special “full build” state, and then drives the system as follows.

When the crawl process completes its current project crawl and requests the next project, it will be given none putting the crawl process into an idle state. It will remain in this state until the full index build is complete.

The extract process is allowed to complete its current project extraction. Further it is given each of the projects awaiting extraction until the extract queue is empty. At this stage the extract process becomes idle and will remain so until it gets more projects from the crawl process (which is being kept idle until the full build is complete).

The build process is allowed to complete building its current project(s) and any further projects in the build queue.

When build has completed the last of the outstanding projects (and moved them to the history log), it requests more work from the queue. At this stage the whole indexing process is idle and the queue manager schedules the full index build by giving the build process a special “do full build” signal.

As described above, when it receives this signal, the build process builds all projects (as dictated by the project metadata) into indexes. On creation of the final index, all indexes are published live.

Finally, the build process signals to the queue manager that the full build is complete. The queue manager then switches back into the normal incremental mode and starts presenting the crawl process with projects to crawl.

Some Possible Modifications

It will be appreciated that many modifications may be made to the system as described above within the scope of the present invention.

For example, although the embodiment described above uses the Fujitsu iTracer search engine, it will be appreciated that the invention could also use other search engines.

1. A computer system comprising a file store for holding a collection of documents, indexing means for constructing and updating at least one index from the contents of the documents, and search means for searching the index to retrieve documents from the file store, wherein the indexing means comprises the following asynchronously executable processes:
(a) a crawl process, for scanning the file store to find documents requiring to be indexed;
(b) an extract process, for accessing the documents requiring to be indexed and extracts indexing data from them; and
(c) a build process, for using the indexing data to construct or update the index.

2. A computer system according to claim 1 including means for enabling a plurality of instances of the extract process to run in parallel.

3. A computer system according to claim 1 wherein each document belongs to one of a plurality of projects, and wherein the indexing means comprises:
(a) a crawl queue, for identifying projects ready to be processed by the crawl process;
(b) an extract queue, for identifying projects that have been processed by the crawl process and are ready to be processed by the extract process; and
(b) a build queue, for identifying projects that have been processed by the extract process and are ready to be processed by the build process.

4. A computer system according to claim 3 including means for preventing further projects from being given to the crawl process while the number of projects in the extract queue is greater than a predetermined threshold value.

5. A computer system according to claim 1 wherein each document belongs to one of a plurality of projects, wherein the system includes means for storing metadata relating to each project, and wherein the crawl process comprises:
(a) means for identifying whether the metadata of a project has changed since a previous scan;
(b) means for scanning the file store only for documents belonging to a project that have been changed, if the metadata for that project is unchanged; and
(b) means for scanning the file store for all documents belonging to a project, if the metadata for that project has been changed.

6. A computer system according to claim 5 wherein the extract process also extracts indexing data from the project metadata and from document metadata.

7. A computer system according to claim 1 wherein each document belongs to one of a plurality of projects, and wherein the system includes a plurality of indexes, and load-sharing means for associating each of the projects with a respective one of the indexes, whereby all the documents belonging to a particular project are indexed in the same index.

8. A computer system according to claim 7 wherein the load sharing means comprises means for keeping a record of the number of documents associated with each of the indexes, means for selecting the one of the indexes associated with the lowest number of documents, and means for associating a new project with the selected one of the indexes.

9. A computer system according to claim 7 wherein the build process comprises means for grouping together for processing a plurality of projects associated with the same index.

10. A computer system according to claim 1, including:
(a) a cache store;
(b) means for updating the cache store with indexing data extracted from the documents whenever the index is incrementally updated; and
(c) means for subsequently updating the index using indexing data held in the cache store, without extracting indexing data from the documents.

11. A computer system according to claim 10 wherein the cache store is organized in a similar structure to that of the file store, whereby cached data for a document can be accessed given the address of the document in the file store.

12. A computer system comprising a file store for holding a collection of documents, indexing means for constructing and updating at least one index from the contents of the documents, and search means for searching the index to retrieve documents from the file store, wherein the computer system also includes:
(a) a cache store;
(b) means for updating the cache store with indexing data extracted from the documents whenever the index is incrementally updated; and
(c) means for subsequently updating the index using indexing data held in the cache store, without extracting indexing data from the documents.

13. A computer system according to claim 12 wherein the cache store is organized in a similar structure to that of the file store, whereby cached data for a document can be accessed given the address of the document in the file store.

14. A computer system according to claim 12 wherein the indexing data comprises body text extracted from the documents.

15. A computer system comprising:
(a) a file store for holding a collection of documents, each document belonging to one of a plurality of projects;
(b) a plurality of indexes;
(c) a mapping table for associating each project with a respective one of the indexes;
(d) indexing means for constructing and updating the indexes from the contents of the documents, all the documents belonging to a particular project being indexed in the index with which that project is associated; and
(e) search means for using the indexes to search for and retrieve documents from the file store.

16. A computer system according to claim 15, wherein the indexing means comprises:
(a) a build queue for holding information identifying a plurality of projects that are ready to have their indexes updated;
(b) means using the mapping table to identify as a target index the index associated with the first project in the build queue; and
(c) means for processing all projects in the build queue associated with the target index, to update the target index with information from the documents associated with those projects.

17. A computer system according to claim 15 including means for keeping a record of the number of documents associated with each of the indexes, means for selecting the one of the indexes associated with the lowest number of documents, and means for associating a new project with the selected one of the indexes.
